(19) United States
(12) Patent Application Publication
(10) Pub. No.: US 2007/0007405 A1
(43) Pub. Date: Jan. 11, 2007

(54) Tension anchorage system

(75) Inventors: Adil Al-Mayah, Kitchener (CA); Khal Soudki, Waterloo (CA); Alan Plumtree, Waterloo (CA)

Correspondence Address: Charles N.J. Ruggiero;Ohlandt, Greeley, Ruggiero & Perle, L.L.P., One Landmark Square, 10th Floor, Stamford, CT, 06901-2682, US

(73) Assignee: University of Waterloo

(21) Appl. No.: 11/454,759

(22) Filed: Jun. 16, 2006

Related U.S. Application Data
(63) Continuation-in-part of application No. 10/574,323.

(51) Int. Cl. F16M 11/00

(52) U.S. Cl. 248/200

(57) ABSTRACT

A wedge anchor for holding a rod under a load is provided. The wedge anchor comprises a barrel comprising a wedge receiving face opposite a rod receiving face. A barrel passage extends therethrough between the wedge receiving face and the rod receiving face. The passage narrows toward the rod receiving face and has an axial cross-sectional profile defining a convex arc having a barrel centre of radius of curvature. The wedge anchor also comprises a plurality of wedges that are insertable into the passage. Each of the wedges comprises an inner wedge face for defining a rod receiving passage for receiving the rod and an outer wedge face, opposite the inner wedge face, in axial cross section having a profile complementary to the convex arc. The outer wedge face has a wedge-face centre of radius of curvature, which is offset relative to the barrel centre of radius of curvature. Each of the wedges further comprise a deformable material having sufficient shear strength to prevent shear stress failure of the wedge and to ensure that the rod is held in place when the wedge anchor is in its loaded configuration.

This application is a continuation-in-part of application Ser. No. 10/574,323, which is the National Stage of International Application No. PCT/CA2003/001469 filed Oct. 3, 2003.

The present invention relates to an anchorage system for fibre reinforced polymer components.

### BACKGROUND OF THE INVENTION

A pre-stressed, pre-tensioned, or post-tensioned, concrete structure has significantly greater load bearing properties compared to an un-reinforced concrete structure. Steel rods or tendons are used almost universally as the pre-stressing or post-tensioning members. The steel rods and associated anchoring components may become exposed to many corrosive elements, such as de-icing chemicals, salt or brackish water. If this occurs, the rods may corrode, thereby causing the surrounding concrete structure to fracture.

Fibre-reinforced polymer (FRP) rods have been used in place of conventional reinforcing rods. The advantages of using a FRP rod include its light weight relative to steel, resistance to corrosion and its high tensile strength, which in some cases may exceed that of steel. Fibre reinforced polymer rods, however, do not have correspondingly high transverse compressive strength. As a result, traditional clamping or anchor mechanisms used for steel rods crush the rod at its load bearing area, which may lead to premature failure of the FRP tendon at the anchorage point. Failure also results when the clamping mechanism provide low contact pressure (or a low bond), which results in the rod pulling out or away from the clamping mechanism.

Many solutions to this problem have been proposed, but none have resolved this problem satisfactorily. For example, Shrive et al (U.S. Pat. No. 6,082,063) proposes a wedge anchor in which the taper of the wedge is greater than the taper of its receiving bore. This differential tapering results in a higher clamping force being applied away from the rod's loaded area. However, Shrive et al requires very precise pre-seating of the wedge. Thus, its effectiveness is largely dependant on the precision of the pre-seating. Further, the Shrive et al design is not a robust design and it is not tolerant of machining inaccuracies.

Hodhod et. al (“Effect of State Stress at the Grips and Matrix Properties on Tensile Strength of CFRP Rods”, Proc. of JSCE 17, 1992, 245-252) investigated the use of wedge anchors having inner faces that were roughened by adhesively bonded iron powder. Kerstens et. al (“Prestressing with Carbon composite Rods: a Numerical Method for Developing Reusable Prestressing Systems”, ACI Structural Journal 95, 1998, 43-50) designed a wedge anchor system for an FRP rod using Nylon 6 for the wedges and treating the rod with a layer of aluminium oxide. In each case, the rod (by compression) or the clamping system (by slipping) failed before the rod's full tensile could be exploited.

There remains a need for a robust and easy to use anchorage system that is able to exploit the high tensile strength and non-corroding properties of carbon fibre reinforced polymer rods.

### SUMMARY OF THE INVENTION

According to the present invention there is provided a wedge anchor for holding a rod under a load. The wedge anchor comprises a barrel comprising a wedge receiving face opposite a rod receiving face. A barrel passage extends therethrough between the wedge receiving face and the rod receiving face. The passage narrows toward the rod receiving face and has an axial cross-sectional profile defining a convex arc having a barrel centre of radius of curvature. The wedge anchor also comprises a plurality of wedges that are insertable into the passage. Each of the wedges comprises an inner wedge face for defining a rod receiving passage for receiving the rod and an outer wedge face, opposite the inner wedge face, in axial cross section having a profile complementary to the convex arc. The outer wedge face has a wedge-face centre of radius of curvature, which is offset relative to the barrel centre of radius of curvature. Each of the wedges further comprises a deformable material having sufficient shear strength to prevent shear stress failure of the wedge and to ensure that the rod is held in place when the wedge anchor is in its loaded configuration.

The deformable material may be selected from the group consisting of wrought iron, low carbon steel, stainless steel, copper, aluminium, alloys thereof, composite materials and hard plastic.

The low carbon steel may be a leaded low carbon steel.

The leaded low carbon steel may be AISI 12L14 carbon steel.

The wedge anchor may comprise three wedges.

The three wedges may be of equal size.

The three wedges may be spaced equally apart.

The inter-wedge spacing when the wedge anchor is in its loaded configuration may be narrow enough to minimize flow of the rod into the inter-wedge space and wide enough to allow the wedges to move into the barrel passage as the load increases.

### BRIEF DESCRIPTION OF THE DRAWINGS

These and other features of the preferred embodiments of the invention will become more apparent in the following detailed description in which reference is made to the appended drawings wherein:

FIG. 1 is a schematic cross-sectional view of a wedge anchor according to an embodiment of the present invention;

FIG. 2 is a schematic cross-sectional view of a wedge anchor according to an alternative embodiment of the present invention;

FIG. 3 is a schematic cross-sectional view of a wedge anchor according to a further alternative embodiment of the present invention;

FIG. 4(a) is a plan view of a wedge of a wedge anchor according to an embodiment of the present invention;

FIG. 4(b) is a cross sectional view of a wedge of a wedge anchor according to an embodiment of the present invention;

FIG. 5 is a cross-sectional view of a wedge and barrel portion of a wedge anchor according to an embodiment of the present invention illustrating the relative contact force exerted along the length of the wedge;

FIG. 6(a) is a schematic cross-sectional view of the rod-sleeve-wedge interface of a pre-seated wedge anchor according to an embodiment of the present invention;

FIG. 6(b) is a schematic cross-section view of the rod-sleeve-wedge interface of a secured wedge anchor according to an embodiment of the present invention;

FIG. 7(a) is a schematic cross-sectional view of the rod-layer-wedge interface of a pre-seated wedge anchor according to an embodiment of the present invention;

FIG. 7(b) is a schematic cross-section view of the rod-layer-wedge interface of a secured wedge anchor according to an embodiment of the present invention;

FIG. 8(a) is a cross-sectional view of a cast concrete structural member;

FIG. 8(b) is a cross-sectional view of the cast concrete structural member of FIG. 8(a) illustrating a wedge anchor according an embodiment of the present invention secured to a fibre reinforced polymer rod;

FIG. 8(c) is a cross-sectional view of the cast concrete structural member of FIG. 8(b) illustrating wedge anchors secured to both ends of the fibre reinforced polymer rod;

FIG. 9 is a schematic representation of a system for testing the tensile strength of a fibre reinforced polymer rod employing a wedge anchor according to an embodiment of the present invention;

FIG. 10(a) is an embodiment of the present invention illustrated in transverse cross-section; and,

FIG. 10(b) is an embodiment of the present invention illustrated in longitudinal cross-section.

### DESCRIPTION OF THE PREFERRED EMBODIMENTS

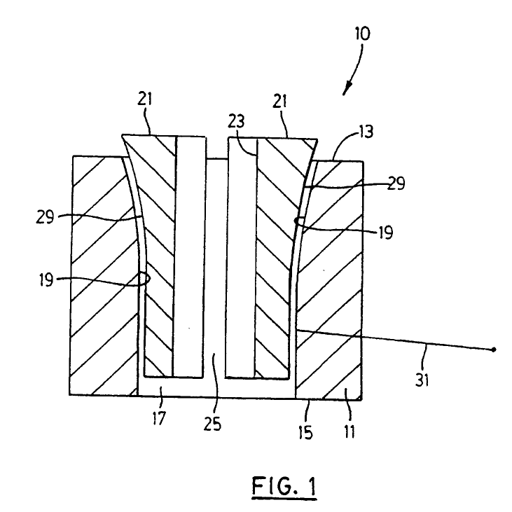

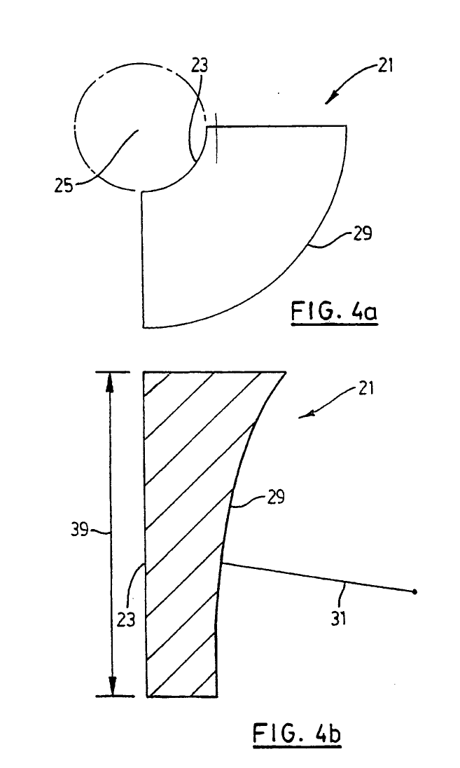

Referring to FIGS. 1 to 4(a) and (b), a wedge anchor 10 according to an embodiment of the present invention is illustrated. The wedge anchor 10 is comprised of a barrel 11 that has a wedge receiving face 13, which is opposite a rod receiving face 15. A passage 17 extends through the barrel 11 between the wedge receiving face 13 and the rod receiving face 15 and narrows toward the rod receiving face 15. In an axial cross-sectional profile, the passage 17 defines a convex arc 19. In a preferred embodiment of the present invention, the axial cross-sectional profile of the convex arc is defined by a radius of curvature 31 described as subtended angle less than 0.5 pi radians. The wedge anchor 10 also includes a plurality of wedges 21, which are insertable into the passage 17. Each of the wedges 21 has a respective inner wedge face 23 for defining a rod receiving passage 25 for receiving a rod 27 and an outer wedge face 29, which is opposite the inner wedge face 23. The outer wedge face 29, in axial cross-section, has a profile complementary to the convex arc 19.

The wedge anchor 10 may include as few as two wedges 21, but generally will employ between 4 and 6 wedges 21. In a preferred embodiment, the wedge anchor 10 is comprised of 4 wedges 21 of equal size.

The wedges 21 have a length 39 selected to ensure that they do not extend beyond the rod receiving face 15 of the barrel 11 when the wedge anchor 10 is in its assembled and secured configuration. In a preferred embodiment, the respective outer wedge faces 29 of wedges 21 have a length 39 less than 0.5 pi radians. In an alternate embodiment, the length of the wedges 21 may extend beyond the rod receiving face of the barrel, provided a cast concrete structural member having a rod receiving entrance is configured to accommodate the extending wedges 21 without hindering the performance of the wedge anchor 10.

The barrel 11 and wedges 21 may be comprised of a hard material, such as a hard metal. In a preferred embodiment, the hard metal is stainless steel. However, any hard material known to those skilled in the art may be employed, such as titanium, copper alloys or ceramic materials. In an alternate embodiment, the barrel 11 and wedges 21 may be comprised of a hard plastic as is known to those skilled in the art.

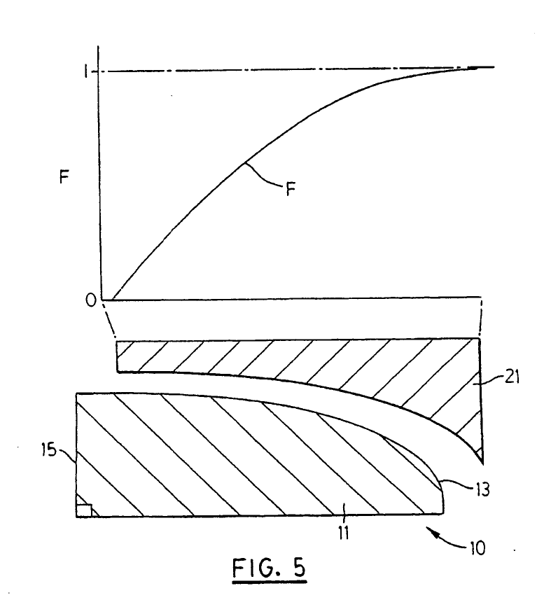

Referring to FIG. 5, a cross-sectional view of a portion of the wedge anchor 10 in its assembled configuration and an accompanying force curve are illustrated. An inward radial or compressive contact force (F) is exerted along the length 39 of the wedge 21 when the wedges 21 are secured in the passage 17. The force curve illustrates the relative inward radial or compressive contact force (F) that is exerted along the length of the wedge 21. Line F illustrates that the compressive force F varies non-linearly over the length of the wedge anchor 10 as a function of the tangent along a surface point of the convex arc 19 and approaches a maximum toward the wedge receiving face 15 of the barrel and a minimum toward the rod receiving face 13 of the barrel 11.

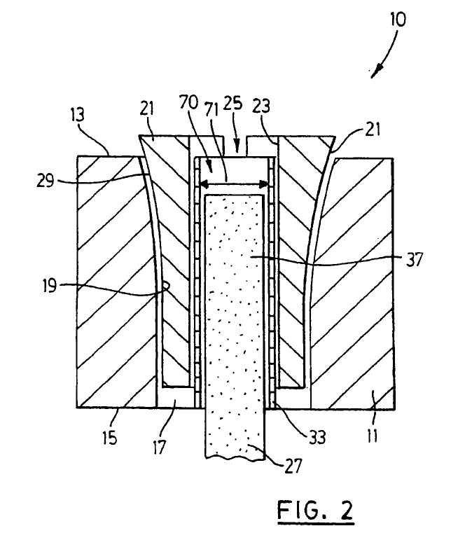

Referring to FIG. 2, a preferred embodiment of the wedge anchor 10 is illustrated, which further includes a sleeve 33, which is insertable into the rod receiving passage 25. The sleeve 33 defines a sleeve passage 70 having an inner sleeve diameter 71 that is configured to receive an end portion 37 of the rod 27. The sleeve 33 may be comprised of a malleable metal. In a preferred embodiment, the malleable metal is cooper or a cooper alloy (e.g. brass or bronze). The sleeve may also be comprised of aluminium, alloys of aluminium, and any other malleable metal known to those skilled in the art.

In an alternate embodiment, the sleeve 33 is comprised of a deformable material having sufficient shear strength to prevent shear stress failure of the sleeve 33 and ensure that the rod 27 is held in place. For example, the sleeve may be comprised of a hard plastic as is known to those skilled in the art.

The sleeve 33 further includes a sleeve inner surface 75, which comes into contact with the rod 27. The sleeve inner surface 75 may be treated with a surface roughening agent (mechanical or chemical), which roughens the sleeve inner surface 75 and thereby enhances the sleeve's 33 ability to hold the rod 27 in place. In a preferred embodiment, the inner surface 75 may be roughened by sandblasting. Any other roughening means known to those skilled in the art may be employed.

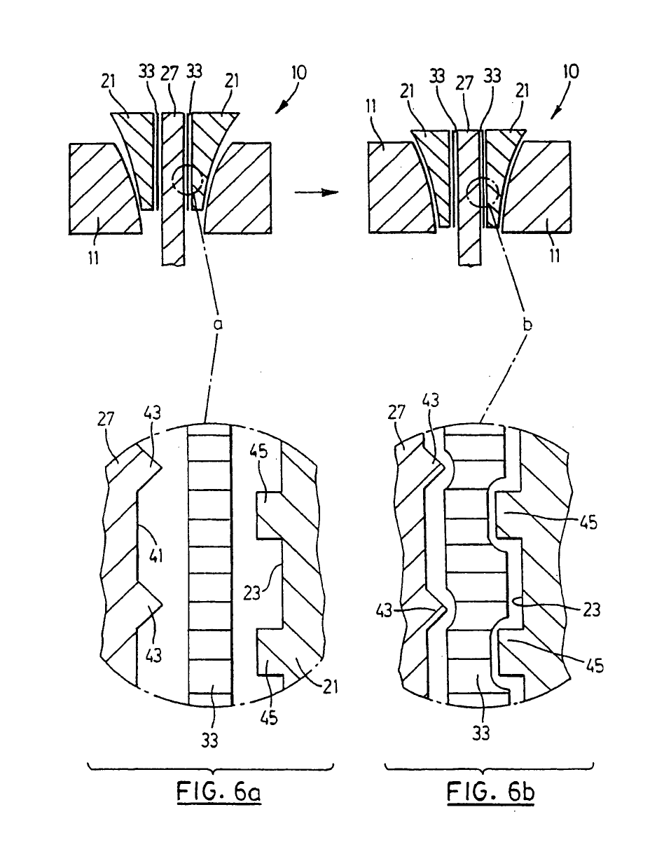

Referring to FIG. 6(a), a wedge anchor 10 and its associated rod 27 are illustrated in their assembled configuration. The interface between rod 27, sleeve 33 and wedge 21 is generally indicated by reference letter A. A magnified view of area A illustrates that rod 27 has an outside surface 41 with surface gaps or irregularities 43. The inner wedge face 23 also has inner wedge face gaps or irregularities 45.

Referring to FIG. 6(b), a wedge anchor 10 and its associated rod 27 are illustrated in a secured configuration. The interface between rod 27, sleeve 33 and wedge 21 is generally indicated by reference letter B. A magnified view of area B illustrates that when the wedges 21 are secured, a radial inward compressive force is applied to the rod 27 via sleeve 33. In effect, the sleeve 33 is squeezed between the rod surface 41 and the inner wedge face 23. This compressive force combined with the gaps and irregularities 43 and 45 causes deformation of the sleeve 33 that corresponds generally to the surface texture of the irregularities 43 and 45, effectively filling any surface gaps or irregularities 43 and 45. Accordingly, the sleeve 33 is selected to be of a thickness to ensure that sufficient sleeve 33 material exists to fill the gaps 43 and 45. In a preferred embodiment, the sleeve thickness is between 0.5 and 0.7 mm (or between 1/15 and 1/20 of the inner diameter 71 of the sleeve 33).

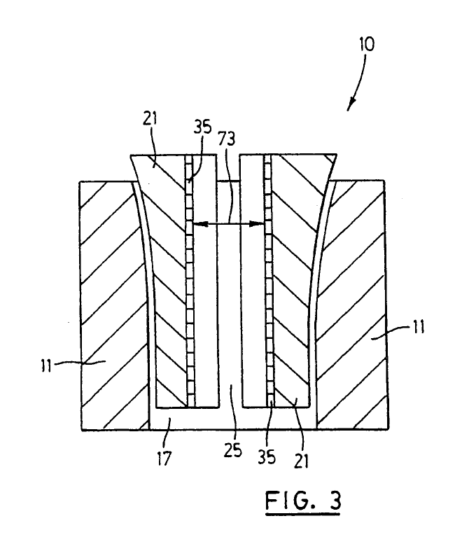

Referring to FIG. 3, an alternate embodiment of a wedge anchor 10 according to the present invention is illustrated, which does not include the sleeve 33. In this embodiment, a layer 35, of the inner wedge face 23 is comprised of a malleable metal. The rod receiving passage 25 has a passage diameter 73. In a preferred embodiment, the malleable metal is copper or a copper alloy (e.g., brass or bronze). The sleeve may also be comprised of aluminium, alloys of aluminium, and any other malleable metal known to those skilled in the art may also be employed.

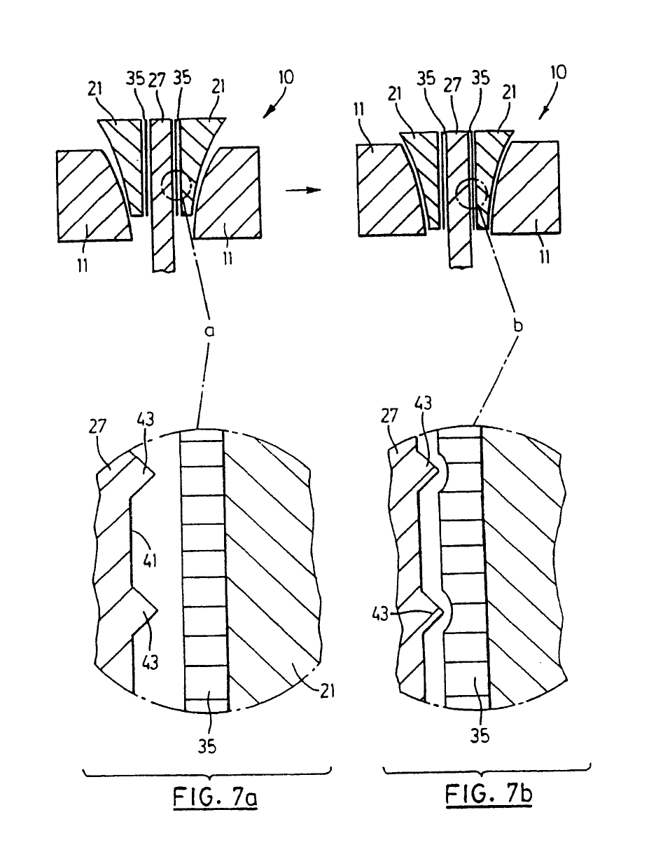

Referring to FIG. 7(a), a wedge anchor 10 and its associated rod 27 are illustrated in their assembled configuration. The interface between rod 27 and wedge 21 is generally indicated by reference letter A. A magnified view of area A illustrates that rod 27 has an outside surface 41 with surface gaps or irregularities 43.

Referring to FIG. 7(b), a wedge anchor 10 and its associated rod 27 are illustrated in a secured configuration. The interface between rod 27 and layer 35 of the wedge 21 is generally indicated by reference letter B. A magnified view of area B illustrates that when the wedges 21 are secured, a radial inward compressive force is applied to the rod 27 via layer 35. In effect, the layer 35 is squeezed between the rod surface 41 and the body of the wedge 21. This compressive force combined with the gaps and irregularities 43 causes deformation of the layer 35 that corresponds generally to the surface texture of the irregularities 43, effectively filling any surface gaps or irregularities 43. Accordingly, the layer 35 is selected to be of a thickness to ensure that sufficient layer 35 material exists to fill the gaps 43. In a preferred embodiment, the layer 35 thickness is between 0.5 and 0.7 mm (or between 1/15 and 1/20 of the passage diameter 73).

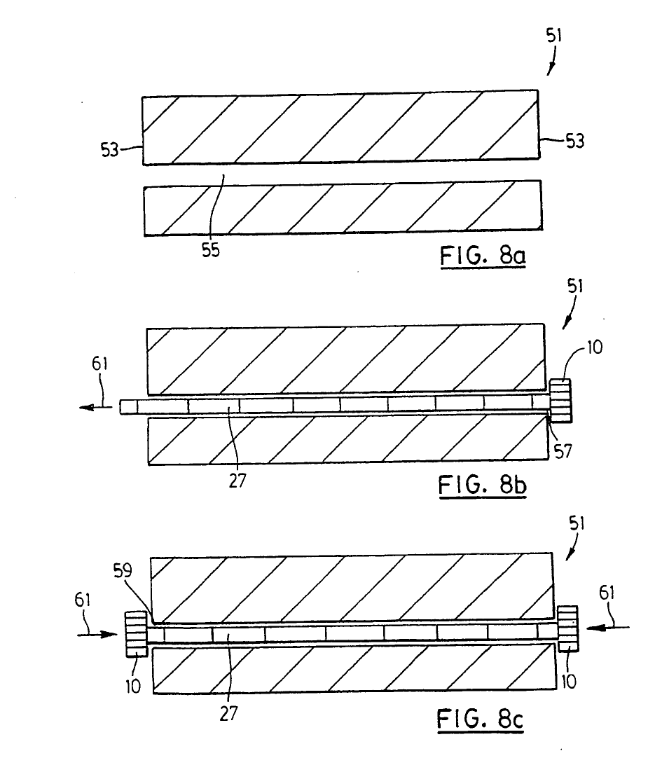

Referring to FIG. 8(a)-(c), a use of the wedge anchor 10 according to an embodiment of the present invention is illustrated. FIG. 8(a) illustrates a cast concrete structural member 51 having respective rod receiving faces 53 at opposite ends of the member 51, with a cavity or passage 55 passing through it between faces 53.

FIG. 8(b) illustrates a fibre reinforced polymer rod 27, such as a carbon reinforced polymer rod, inserted in passage 55 and passing through member 51. A wedge anchor 10 is secured to a first end 57 of the rod 27. Once secured, a tensile force is applied to an opposite end 59 of the rod 27. Once a desired tensile force is applied, a second wedge anchor 10 is secured to the opposite end 59 of the rod 27, thereby maintaining the tension over the length of the rod 27 and resulting in a compressive force, as indicated by force arrows 61, being applied to the member 51 (FIG. 8(c)).

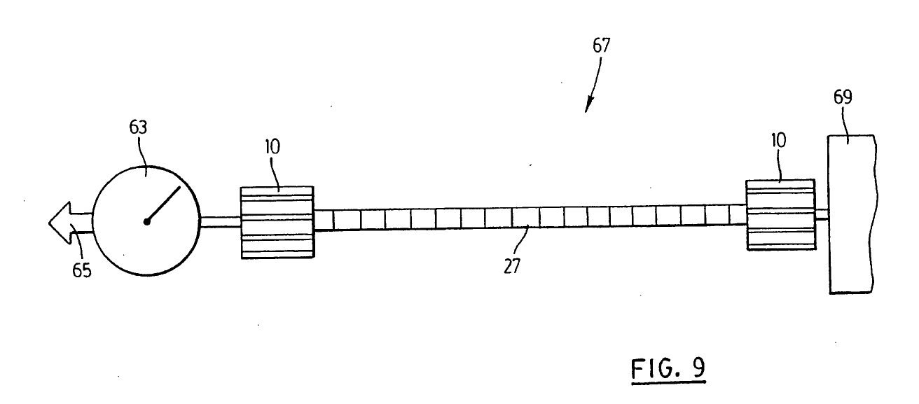

Referring to FIG. 9, a system 67 for testing the tensile strength of a fibre reinforced polymer rod 27 is illustrated. The system 67 comprises a wedge anchor 10, which is secured to a test base 69. The wedge anchor 10 is also secured to one end of the rod 27. At an opposite end of the rod 27, a second wedge anchor 10 is secured. The second wedge anchor 10 is in turn connected to a force measuring unit 63, such that as a tensile force, as indicated by arrow 65, is applied, it is measured by the measuring unit 63. In order to test the tensile strength of a rod 27, the tensile force 65 applied to the system 67 is increased until the force 65 applied exceeds the tensile strength of the rod 27 and the rod 27 breaks. As the force 65 is applied, the measuring unit 63 measures the applied tensile force 65 and as such measures the force 65 applied at the moment the rod 27 breaks.

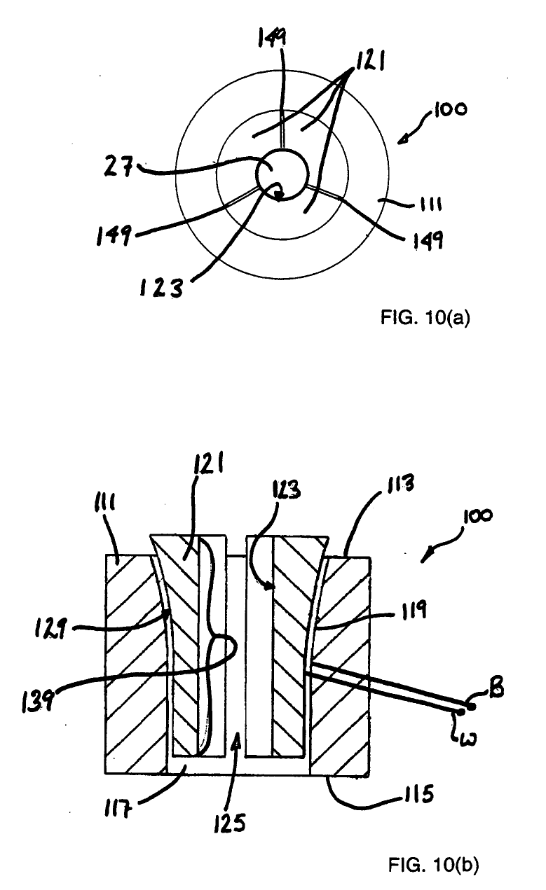

Referring to FIGS. 10(a) and 10(b), an additional wedge anchor 100 is illustrated in transverse cross-section (10(a)) and longitudinal cross-section (10(b)). The wedge anchor 100 comprises a barrel 111, which in turn comprises a wedge receiving face 113 opposite a rod receiving face 115. A barrel passage 117, which extends through the barrel 111 between the wedge receiving face 113 and the rod receiving face 115, narrows toward the rod receiving face 115 and has an axial cross-sectional profile that defines a convex arc 119 having a barrel centre of radius-of-curvature (B).

The wedge anchor 100 also comprises a plurality of wedges 121 (preferably three) that are insertable into the passage 117. Each of the wedges 121 in turn comprises: a respective inner wedge face 123 which defines a rod receiving passage 125 for receiving a rod; an outer wedge face 129, opposite the inner wedge face 123, which in axial cross-section has a profile complementary to the convex arc 119. The outer wedge face 129 has a wedge-face centre of radius-of-curvature (W), which is offset relative to the barrel centre of radius-of-curvature (B).

The wedges 121 further comprise a deformable material having sufficient shear strength to prevent shear stress failure of the wedges 121 and ensure that the rod 27 is held in place when the wedge anchor 121 is in its loaded configuration.

The wedges 121, for example, may be comprised of a hard plastic as is known to those skilled in the art.

Alternately, the deformable material is selected from the group consisting of wrought iron, low carbon steel, stainless steel, copper, aluminium, alloys thereof, and composite materials. Preferably, the low carbon steel is a leaded low carbon steel, such as AISI 12L14 carbon steel. Low carbon steels, being relatively soft and ductile, allow the wedges 121 to play the dual role of protection medium (in which it prevents compressive failure of the rod 27) and gripping component (in which it holds the rod 27 in position).

The hardness of the wedge 121 material selected is determined to an extent by the particular geometry of the wedge anchor 100 components. For example, longer wedge anchors permit softer wedge 121 materials to be used.

The wedges 121 preferably have a length 139 selected to ensure that they do not extend beyond the rod receiving face 115 of the barrel 111 when the wedge anchor 100 is in its assembled and secured (loaded) configuration. In a preferred embodiment, the respective outer wedge faces 129 of wedges 121 have a length 139 less than 0.5 pi radians.

As stated, the wedge anchor 100 preferably comprises three wedges 121. The number of wedges 121 selected is related to the particular geometry of the wedge anchor 100: the fewer the number of wedges 121 of a given size that are used, the lower the overall gripping (holding) force provided by the wedges 121; the longer the length of the wedge 121, the greater the overall gripping force provided. Thus, if a particular gripping force is required, the number of wedges 121 or length of the wedges 121 (and therefore the length of the wedge anchor 100) is adjusted accordingly.

In a preferred embodiment, the three wedges 121 are of equal size, and are spaced equally apart.

Referring to FIG. 10(a), the inter-wedge spacing 149 when the wedge anchor 100 is in its loaded configuration is narrow enough to minimize flow of the rod 27 into the inter-wedge space 149 and wide enough to allow the wedges 121 to move into the barrel passage 117 as the load borne by the rod 27 and wedge anchor 100 increases. Preferably, the inter-wedge spacing 149 is wide enough to allow the full lengths of the wedges 121 to move into the barrel passage 117. Minimising the flow of the rod 27 material into the inter-wedge spacing 149 prevents the formation of stress concentration at these flow points, which as a result reduces the likelihood of having premature failure of the rod 27.

The barrel 111 may be comprised of a hard material, such as a hard metal. In a preferred embodiment, the hard metal is stainless steel. However, any hard material known to those skilled in the art may be employed, such as titanium, copper alloys or ceramic materials. In an alternate embodiment, the barrel 111 may be comprised of a hard plastic as is known to those skilled in the art.

Testing:

A single spiral indented CFRP rod having a diameter of 9.4 mm was tested using the wedge anchor 100. The rods 27 were manufactured using a peel-ply system. The composite was made of 60% volume fraction carbon fiber in a vinylester epoxy resin matrix.

Installation of the wedge anchor 100 began by cleaning the wedges 121, barrel 111 and rod 27 with acetone. A thin layer of lubricant (G-n Metal Assembly Paste) was applied to the outer surfaces of the wedges 121 so as to facilitate insertion in the barrel 111. The wedges 121 were arranged evenly around the rod 27 to ensure a uniform distribution of contact pressure on the rod 27. No presetting was applied. The wedges 121 were tapped lightly into the barrel 111.

Each test was terminated on failure of the rod.

The wedge anchor 100 was tested under static loading conditions and the load-displacement relationship was monitored. No relative slip was observed between the wedges 121 and the rod 27. The results of tensile loading using the wedge anchor 100 and results reported by the rod manufacturer using a 254 mm long epoxy potted anchor are listed in the table below. The average of the failure load using the wedge anchor 100 is higher than the rod manufacturer obtained with the potted anchor.

TABLE
Failure Load of the CFRP rods 27 using wedge anchor 100 and
epoxy potted anchor

FAILURE LOAD (KN)

| | | Epoxy Potted Anchor |
|---|---|---|
| | | (results provided by rod |
| Test No. | Wedge Anchor 100 | manufacturer) |
| 1 | 135.94 | 132.91 |
| 2 | 134.33 | 117.51 |
| 3 | 132.25 | 128.52 |
| 4 | 128.1 | 132.88 |
| 5 | 144.1 | 129.92 |
| 6 | 130.34 | 139.9 |
| 7 | 125 | 121.24 |
| 8 | 121.81 | 129.92 |
| 9 | 130.32 | |
| Average | 131.35 | 129.1 |

Although the invention has been described with reference to certain specific embodiments, various modifications thereof will be apparent to those skilled in the art without departing from the spirit and scope of the invention as defined by the claims set out below.

We claim:

1. A wedge anchor for holding a rod under a load, the wedge anchor comprising:
a barrel comprising a wedge receiving face opposite a rod receiving face, a barrel passage extending therethrough between the wedge receiving face and the rod receiving face, the passage narrowing toward the rod receiving face and having an axial cross-sectional profile defining a convex arc having a barrel centre of radius of curvature; and,
a plurality of wedges insertable into the passage, each of the wedges comprising an inner wedge face for defining a rod receiving passage for receiving the rod and an outer wedge face, opposite the inner wedge face, in axial cross section having a profile complementary to the convex arc, the outer wedge face having a wedge-face centre of radius of curvature, which is offset relative to the barrel centre of radius of curvature, each of the wedges further comprising a deformable material having sufficient shear strength to prevent shear stress failure of the wedge and to ensure that the rod is held in place when the wedge anchor is in its loaded configuration.

2. A wedge anchor according to claim 1, wherein the deformable material is selected from the group consisting of wrought iron, low carbon steel, stainless steel, copper, aluminium, alloys thereof, composite materials and hard plastic

3. A wedge anchor according to claim 2, wherein the low carbon steel is a leaded low carbon steel.

4. A wedge anchor according to claim 3, wherein the leaded low carbon steel is AISI 12L14 carbon steel.

5. A wedge anchor according to claim 1 comprising three wedges.

6. A wedge anchor according to claim 5, wherein the three wedges are of equal size.

7. A wedge anchor according to claim 6, wherein the three wedges are spaced equally apart.

8. A wedge anchor according to claim 7, wherein the inter-wedge spacing when the wedge anchor is in its loaded configuration is narrow enough to minimize flow of the rod into the inter-wedge space and wide enough to allow the wedges to move into the barrel passage as the load increases.

9. A wedge anchor according to claim 8, wherein the inter-wedge spacing is wide enough to allow the full lengths of the wedges to move into the barrel passage.

10. A wedge anchor for holding a rod under a load, the wedge anchor comprising:
a barrel comprising a wedge receiving face opposite a rod receiving face, a passage extending therethrough between the wedge receiving face and the rod receiving face, the passage narrowing toward the rod receiving face and having an axial cross-sectional profile defining a convex arc having a barrel centre of radius of curvature; and,
three wedges of equal size insertable into the passage, each of the three wedges comprising:
an inner wedge face for defining a rod receiving passage for receiving the rod and an outer wedge face, opposite the inner wedge face, in axial cross section having a profile complementary to the convex arc, the outer wedge face having a wedge-face centre of radius of curvature, which is offset relative to the barrel centre of radius of curvature, and,
a leaded low carbon steel having sufficient shear strength to prevent shear stress failure of the wedge and to ensure that the rod is held in place when the wedge anchor is in its loaded configuration,
the three wedges having an inter-wedge spacing when the wedge anchor is in its loaded configuration narrow enough to minimize flow of the rod into the inter-wedge space and wide enough to allow the wedges to move into the barrel passage as the load increases.

11. A wedge anchor according to claim 10, wherein the leaded low carbon steel is AISI 12L14 carbon steel.
